(19) United States
(12) Patent Application Publication
(10) Pub. No.: US 2015/0290609 A1
(43) Pub. Date: Oct. 15, 2015

(54) PROPPANT DELIVERY SYSTEM AND METHOD

(71) Applicants: Brent Naizer, Tomball, TX (US); Blake Burnette, Tomball, TX (US)

(72) Inventors: Brent Naizer, Tomball, TX (US); Blake Burnette, Tomball, TX (US)

(73) Assignee: BAKER HUGHES INCORPORATED, Houston, TX (US)

(21) Appl. No.: 14/249,564

(22) Filed: Apr. 10, 2014

(51) Int. Cl. B01F 15/04; B65G 15/28; B01F 3/12; G05D 11/04; B01F 15/02

(52) U.S. Cl. CPC B01F 15/0445; B01F 15/0483; G05D 11/04; B01F 15/0235; B01F 15/0229; B01F 3/12; B01F 3/1214; B65G 15/28; B01F 2015/0204; B01F 2215/0081

(57) ABSTRACT

A proppant delivery system for a fracturing fluid blending system. The proppant delivery system includes an automatic feed-screwless proppant dispensing unit configured to deliver proppant directly to a blender opening of a blender. A weighing device on an upstream side of the blender configured to weigh the proppant during delivery of the proppant to the blender. Also included is a method of delivering proppant to a fracturing fluid blender.

### BACKGROUND

In the drilling and completion industry, the formation of boreholes for the purpose of production or injection of fluid is common. The boreholes are used for exploration or extraction of natural resources such as hydrocarbons, oil, gas, water, and alternatively for CO2 sequestration. To increase the production from a borehole, the production zone can be fractured to allow the formation fluids to flow more freely from the formation to the borehole. The fracturing operation includes pumping fluids at high pressure towards the formation to form formation fractures. To retain the fractures in an open condition after fracturing pressure is removed, the fractures must be physically propped open, and therefore the fracturing fluids commonly include solid granular materials, such as sand, generally referred to as proppants.

The granular material used for proppant can be brought to the borehole location via road, rail, or water. Transportable containers containing the proppant are situated at an area near the borehole and a conveyor belt system is used to deliver the proppant to a hopper, which subsequently feeds to a blender via feed screws as needed. Such feed screws, or screw conveyors, employ a rotating helical screw blade to move the proppant from the hopper to the blender opening. The rate of volume transfer is proportional to the rotation rate of the screw, and the feed screw can be operated with the flow of material inclined upward to the blender feed opening.

The blender can also receive a number of other materials including water and dry or fluidic chemical additives to create the fracturing fluid. The additives are added by an operator or hopper, while the liquid materials are delivered to the blender from a water source using hoses. The blender produces a proppant-laden fracturing fluid, also known as slurry. The slurry is discharged from the blender via a discharge flow line (slurry line) and pumped into the borehole by high pressure pumps. In order to achieve the correct proportion of proppant and water, the amount of proppant added to the blender is monitored by measuring the density of the slurry being discharged from the blender through use of a densometer at the slurry line. The greater the density of the slurry, the more proppant in the slurry, and likewise the less dense the slurry, the less proppant in the slurry. A suitable density can be achieved by increasing or decreasing one or both of the water and proppant added to the blender until the desirable density of the slurry is achieved. One such densometer is the nuclear densometer that uses a radiation source positioned against one side of the slurry line and a radiation detector positioned against the opposite side. The amount of radiation that actually reaches the detector is proportional to the density of the fluid. If the relative amounts of all other components in the slurry remain constant, the greater the density of the slurry (the more proppant in the slurry), the more radiation will be absorbed in the slurry and the less radiation will be detected.

As time, manpower requirements, and mechanical maintenance issues are all variable factors that can significantly influence the cost effectiveness and productivity of a fracturing operation, the art would be receptive to improved and/or alternative apparatus and methods for delivering proppant to a blender for processing fracturing fluids.

### BRIEF DESCRIPTION

A proppant delivery system for a fracturing fluid blending system, the proppant delivery system includes an automatic feed-screwless proppant dispensing unit configured to deliver proppant directly to a blender opening of a blender; and, a weighing device on an upstream side of the blender configured to weigh the proppant during delivery of the proppant to the blender.

A method of delivering proppant to a fracturing fluid blender, the method includes arranging a downstream end of a conveyor belt to deliver proppant directly to a blender opening of a blender.

A method of delivering proppant to a fracturing fluid blender, the method includes utilizing an automatic feed-screwless proppant dispensing unit to deliver proppant directly to a blender opening of a blender; and, weighing the proppant during delivery of the proppant to the blender with a weighing device on an upstream side of the blender.

### BRIEF DESCRIPTION OF THE DRAWINGS

The following descriptions should not be considered limiting in any way. With reference to the accompanying drawings, like elements are numbered alike:

FIG. 1 shows a schematic diagram of an exemplary embodiment of a proppant deliver system within an exemplary fracturing fluid process plant;

FIG. 2 shows perspective view of an exemplary support structure, exemplary blender tub, and an exit portion of an exemplary proppant silo for the fracturing fluid process plant of FIG. 1;

FIG. 3 shows a cross-sectional view of an exemplary embodiment of a blender tub and an exit portion of a silo;

FIG. 4 shows a perspective view of an exemplary embodiment of a load cell for a weighing device;

FIG. 5 shows a perspective view of another exemplary embodiment of a load cell for a weighing device;

FIG. 6 shows a side view of another exemplary embodiment of a proppant delivery system;

FIG. 7 shows a side view of still another exemplary embodiment of a proppant delivery system; and,

FIG. 8 shows a side cross-sectional view of a housing for the embodiments of a proppant delivery system of FIGS. 6 and 7.

### DETAILED DESCRIPTION

A detailed description of one or more embodiments of the disclosed apparatus and method are presented herein by way of exemplification and not limitation with reference to the Figures.

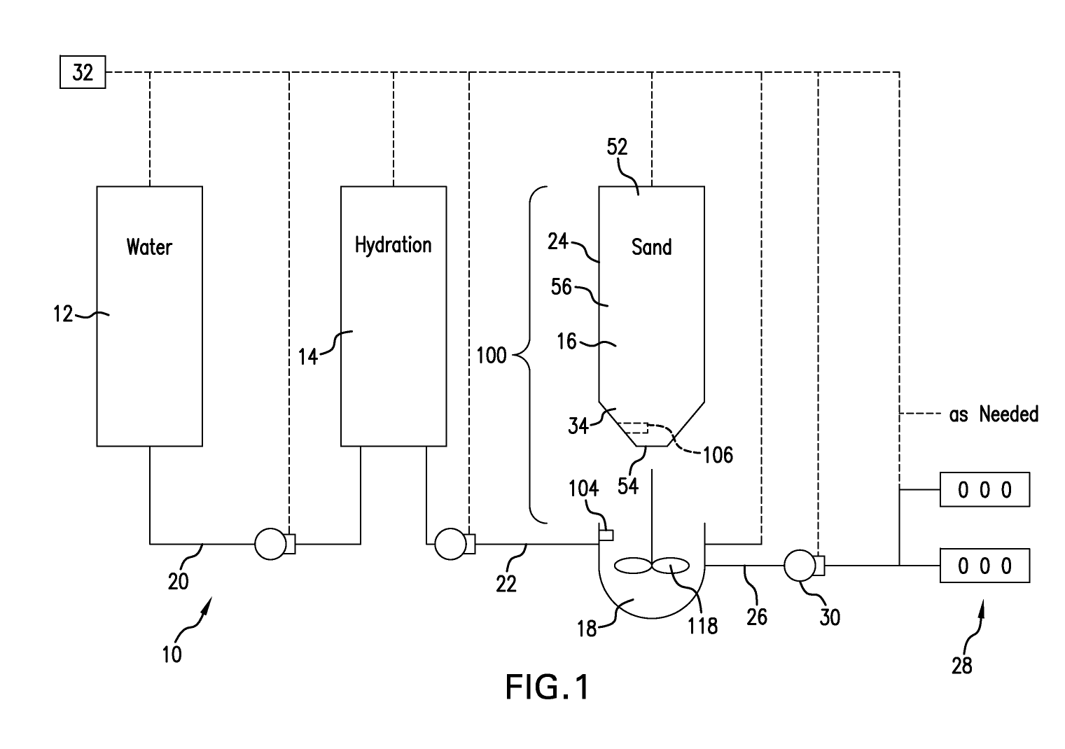

FIG. 1 shows one exemplary embodiment of a proppant delivery system 100 that delivers proppant to a blender 18 without the use of sand screws and without the need for a nuclear densometer at a discharge line of the blender 18 to determine the density of the proppant in the blended slurry. FIG. 1 shows an overview of a fracturing fluid process plant 10 incorporating the proppant delivery system 100. While the plant 10 is described for the preparation of slurry used as fracturing fluid, the plant 10 may also be employed for the creation of other mixtures. The plant 10 includes a water supply module 12, a chemical additive supply module 14, a proppant supply module 16, and blender 18. While water is specified as the liquid within the water supply module 12, it should be understood that alternative liquids may be employed including treated water, a water solution including water and one or more other elements or compounds, or another liquid. The water supply module 12 includes water or treated water stored in a tank, silo, or the like situated at any location convenient to the plant 10. Alternatively, the water supply can be brought to the site within a tanker truck, locomotive, etc. In an exemplary embodiment, the water supply module 12 is seated on a base, platform, or trailer bed, hereinafter referred to as a “base” that will be further described below. Water from the water supply module 12 is directed to the chemical additive supply module 14 via a water line 20. This process of delivering water to the chemical additive supply module 14 is relatively uncomplicated because water is a free-flowing liquid. The chemical additive supply module 14 is typically a powder material and not capable of freely flowing through lines without the addition of water. Like the water supply module 12, the chemical additive supply module 14 can be delivered to the site and seated upon the base of the fracturing fluid process plant 10. The chemical additive can include any material, including food grade materials. When the water from the water line 20 is added to the chemical additive supply module 14, a mixture such as a gel is formed. Water from the water line 20 and chemical additive from the chemical additive supply module 14 may be mixed in a blender (not shown). The resultant gel is capable of flowing through a gel line 22. The gel line 22 is attached to the blender 18.

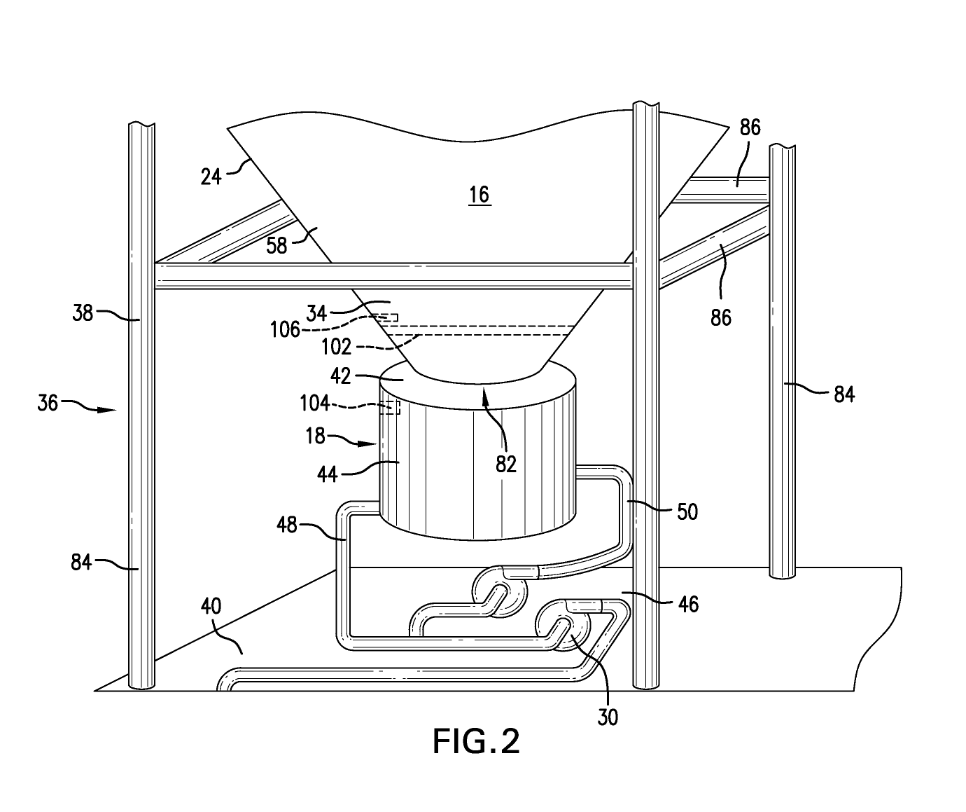

Proppant, such as, but not limited to, sand, which is also not capable of flowing through lines on its own, is added directly to the blender 18 from the proppant supply module 16 to be combined with gel from the gel line 22. In one exemplary embodiment, as will be further described with respect to FIG. 2, the proppant is added directly to the blender 18 from a silo 24 instead of being carried by a conveyor belt or delivered via a hopper. Thus, sand screws are not required in the proppant delivery system 100 of FIG. 1. The combination of proppant and gel within the blender tub 18 forms a fracturing fluid slurry that flows through a slurry line 26 towards one or more high pressure pumps 28 for delivery into the borehole (not shown). A centrifugal pump 30 is used at the slurry line 26 for delivering the slurry from the blender 18 to the pumps 28. The centrifugal pump 30 receives the fluid from the blender 18, and converts rotational energy of the fluid, such as through the use of a pump impeller within the centrifugal pump 30, to moving energy of the fluid towards the high pressure pumps 28. While potentially unnecessary, centrifugal pumps 30 may also be employed at the water line 20 and gel line 22 as needed.

The flow of water through the water line 20, gel through the gel line 22, and slurry through the slurry line 26 may all be electrically controlled via a central control system 32. The control system 32 allows an operator to control actuated valving at the water line 20, gel line 22, and slurry line 26 to route the fluids as needed. The control system 32 may also be in electrical communication with the water supply module 12, chemical additive supply module 14, proppant supply module 16, and blender 18 for monitoring and metering each material and controlling their combination. The control system 32 may additionally be in communication with the high pressure pumps 28, or in communication with controls (not shown) of the high pressure pumps 28. For example, a control of the high pressure pumps 28 may indicate to the control system 32 that more fracturing fluid is required, which in turn will signal the production of additional fracturing fluid slurry to the components of the fracturing fluid process plant 10.

Instead of including a nuclear densometer at the upstream side of the blender 18, such as along the slurry line 26, which would determine the density of the proppant within the slurry, a weighing device 104, 106 is included in at least one of the proppant supply module 16 and the blender 18. For exemplary purposes, the weighing device 104, 106 is shown at both locations, although it should be understood that only one weighing device is required. The weighing device 106 is positioned to sense the weight of upstream proppant. If the weighing device 104 is used at the blender 18, then the blender 18 must bear at least some of the weight of the proppant supply module 16, such as by allowing it to rest on the opening of the blender 18, which would require the blender 18 to be designed to support such a weight.

FIG. 2 shows a portion of the fracturing fluid process plant 10 including transportable silo 24. The fracturing fluid process plant 10 in this exemplary embodiment is a “flip up” electric fracturing fluid process plant in that the transportable silo 24 of the proppant supply module 16 is carried to the plant 10 and then “flipped up” to allow the proppant to flow through an exit portion 34 of the silo 24 due to gravity. The silo 24 is supported by a support structure 36, the support structure 36 including support beams 38 and a base 40. The silo 24 includes the exit portion 34 substantially longitudinally aligned with a mouth or opening 42 of the blender tub 44. That is, an output port 82 of the silo 24 is vertically aligned with the opening 42. In an exemplary embodiment, the exit portion 34 is sized for situating directly upon the opening 42. The blender tub 44 is seated on a blender tub receiving area 46 of the base 40. The blender tub 44 is thus supported on the base 40 of the support structure 36. At least one fluid connection piping 48 for introducing additional material, such as gel from the gel line 22, into the blender tub 44, is integrated into or fixedly secured to the base 40. Additionally, at least one fluid connection piping 50 for delivering fracturing fluid slurry from the blender tub 44 to the hydraulic high pressure pumps 28 (FIG. 1) is integrated into or fixedly secured to the base 40.

The transportable silo 24 includes an upstream end 52 and a downstream end 54. The exit portion 34 is located adjacent the downstream end 54. The upstream end 52 may include an accessible opening (not shown) for receiving proppant prior to delivery at the location, or for refilling as needed. The silo 24 is delivered to the fracturing fluid process plant 10, and contains an amount of proppant, such as the quantity required for preparing the slurry, or more or less than the quantity required for preparing the slurry. The control system 32 can be used to control the amount of proppant added to the blender tub 44 at any particular time. Weight information from one or both of the weighing devices 104, 106 is useable by the control system 32.

While the proppant contained within the silo 24 is typically sand, the fracturing fluid fracturing process plant 10 is not limited to a sand-filled silo. Other proppants storable within the silo 24 include, but are not limited to, glass beads, sintered metals, walnut shells, etc. Also, while the silo 24 disclosed herein is described for carrying proppant, other materials for a fracturing fluid slurry may be stored within the silo 24, although the exit portion 34 would have to be designed to allow for the proper exit of a material, such as fluidic material or a powder material, to be properly dispensed from the silo 24.

The silo 24 includes a storage tank portion 56 directly connected to the exit portion 34 and upstream of the exit portion 34, such that proppant material upstream of the exit portion 34 can readily flow downstream due to gravity towards the exit portion 34 when the silo 24 is in an upright or tilted position. The exit portion 34 includes a tapered surface 58, such as a cone shape, which assists in mating with the blender tub 44 in one exemplary embodiment. The tapered surface 58 of the exit portion 34 also allows for a limited and controlled egress of the proppant from the storage tank portion 56 into the blender tub 44. To prevent premature delivery of the proppant from the storage tank portion 56 to the blender tub 44 and to prevent over-filling the blender tub 44 at any one time, a selective blocking member 102, such as a gate, valve, and/or metering system can be further included within the silo 24.

The selective blocking member 102 may include a gate positioned in the exit portion 34, or between the exit portion 34 and the storage tank portion 56. In an exemplary embodiment, the gate may include a butterfly valve, to isolate or regulate flow from the storage tank portion 56 to the blender tub 44. The butterfly valve can enable quick shut off of flow. The butterfly valve may be electrically controlled, such as via control system 32, and an operator portion, typically a lever, should be further included to manually adjust or close the valve as necessary. The exit portion 34 of the silo 24 may alternatively or additionally include a cone valve that can be electrically or mechanically actuated to release the proppant from the silo 24 to the blender tub 44. The silo 24 may incorporate a metering system to dole out a selected amount of proppant to the blender tub 44, such as a variable aperture device. Any of the above-described gates, valves, and metering systems, as well as other selective blocking members 102, can be used separately or in combination within the silo 24 depending on customer requirements for a particular job or the type of proppant contained within the silo 24. The weighing device 106 may be positioned adjacent the selective blocking member 102. In particular, the weighing device 106 may use a portion (such as a fixed portion) of the selective blocking member 102 that carries the weight of whatever proppant remains above it within the silo 24. Although, alternatively, any separate (or integral within weighing device 106) weighing shelf may be used such that changes in the strain experienced by the weighing shelf are detected by the weighing device 106.

Other possible components for the silo 24 that are not shown include, but are not limited to, a vent pipe or venting structure at an upstream end 52 of the silo 24, ladder and ladder cage with handrails, catwalks, level indicators, view glass, and pressure release valve.

The transportable silo 24 of the proppant supply module 16 is tilted upward to rest in a tilted or an upright position within the support structure 36 as shown in FIG. 2. In an alternative exemplary embodiment, some of the support beams 38 may be disposed about the silo 24 prior to flipping up the silo 24 into the upright position, while some or a portion of the support beams 38, such as receiving rods, can be fixedly attached to the base 40 for alignment and receipt of the remainder of the support beams 38. In yet another exemplary embodiment, the base 40 includes apertures (not shown) for receiving support beams 38 that surround the silo and are alignable within the apertures of the base 40. Once the silo 24 is in the tilted or upright position, the support structure 36 maintains the silo 24 in a fixed position relative to the base 40. The support structure 36 may include a plurality of vertical support beams 84 and a plurality of cross beams 86 that interconnect adjacent vertical support beams 84. The cross beams 86 may be straight or have a curved shape.

As previously described, the base 40 includes piping, including first piping 48, for delivering components, other than components dispensed from the silo 24, to the blender tub 44. These other components include components necessary for blending with the proppant to form the slurry used as a fracturing fluid, and thus the first piping 48 is attached to gel line 22. The piping also includes second piping 50 for attachment with the slurry line 26, for delivering the slurry from the blender 18 to the high pressure pumps 28. In the exemplary embodiment of the fracturing fluid process plant 10, the piping 48, 50 includes rigid or at least substantially inflexible tubing or tubing pieces that are interconnected by tees and elbows as needed. The piping design allows for long-term purposes or a substantially permanent design that eliminates the need for dragging, lifting, and aligning flexible hoses during set-up of the fracturing fluid process plant 10. By fixedly positioning the piping 48, 50 relative to and onto the base 40 relative to the blender tub receiving area 46, set-up time is reduced. The piping 48, 50, may further include centrifugal pumps 30 as needed for directing the fluids to and from the blender tub 44. As will be further described below, the base 40 further includes additional piping extending from the blender 18 to the water supply module 12 as well as piping interconnecting the water supply module 12 and the chemical supply module 14. In one exemplary embodiment, the piping on the base 40 is arranged such that the water supply module 12 and the chemical supply module 14 may be interchangeably situated on the base 40 since the piping includes connection points at each module 12, 14, 16 allowing for fluid to be routed to and from any of the modules 12, 14, 16.

The blender tub 44 is sized for receiving and blending the components of the fracturing fluid slurry. In one exemplary embodiment, because the silo 24 is designed to seat directly on top of the opening 42 of the blender tub 44, the blender tub 44 is closed off by the silo 24 so that components of the fracturing fluid cannot escape the blender tub 44 during blending. In an exemplary embodiment, the blender tub 44 is fitted onto the exit portion of the sand silo 24 prior to being set up onto the base 40. That is, the transportable silo 24 includes the blender tub 44 secured at its downstream end 54 during transport. When at the site, the blender tub 44 and silo 24 can be tilted onto the base 40 in unison, and then the pipes 48, 50 can be connected to the blender tub 44 using connections such as, but not limited to, clamps to complete the rig up process. In another alternative exemplary embodiment, the blender tub 44 is situated on the base 40 of the support structure 36 awaiting the transportable silo 24. The opening 42 of the blender tub 44 includes a smaller opening mouth than a diameter of the storage tank portion 56 of the silo 24, but a diameter of at least one portion of the exit portion 34 of the silo 24 is smaller than the opening 42 in order to dispense the contents of the silo 24 into the blender tub 44 without spilling. The selective blocking member 102 can be utilized by an operator to limit the quantity of material dispensed from the silo 24 into the blender tub 44, and to adjust the rate of flow of the proppant supply 16 dispensed from the silo 24 into the blender tub 44.

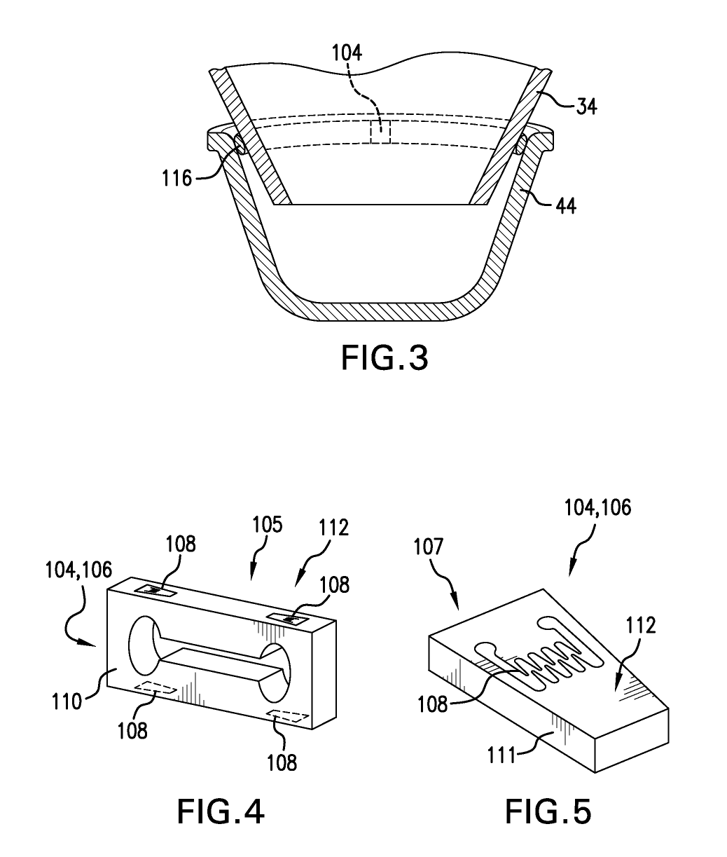

While in one exemplary embodiment, the silo 24 is arranged above the opening 42 of the blender tub 44, such an embodiment would likely require a cover or closing member (not shown) for the opening 42 during blending. To eliminate the need for such a cover, in another exemplary embodiment, the blender tub 44 includes an engagement feature for engaging with an engagement feature of the silo 24 to provide a connection there between. The engagement feature of the silo 24 can be included on the tapered surface 58 of the exit portion 34 of the silo 24. In addition to providing a fixed connection between the blender tub 44 and the silo 24, as shown in FIG. 3, a seal 116 can surround one or both of the blender tub opening 42 and the exit portion 34 to ensure a sealed connection there between, thus preventing any of the materials from exiting the blender tub 44 during blending through the use of a mixing apparatus 118, such as blender blades or the like within the blender tub 44. The weighing device 104 may be positioned adjacent to the seal 116, such that the weighing device is pinched between the inside of the blender tub 44 and the outside of the silo 24.

As shown in FIGS. 4 and 5, each weighing device 104, 106 includes a load cell that will serve to indicate a loss of weight in the vertically arranged silo 24 as proppant is dispensed into the blender 18. Exemplary load cells 105, 107 shown in FIGS. 4 and 5 include one or more strain gauges 108. FIG. 4 shows an embodiment of load cell 105 having a plurality of strain gauges 108, while FIG. 5 shows an embodiment of load cell 107 having a single strain gauge 108. In either embodiment, the load cell 105, 107 is designed with a spring body 110, 111 supporting the strain gauge(s) 108 thereon. The strain gauge(s) 108 become distorted when a bending force, as demonstrated by arrow 112, presses against the spring body 110, 111. Distortion of the strain gauge(s) 108 is detected as a change in the electrical resistance thereof. As proppant is released from the silo 24 into the blender 18, the amount of distortion decreases, thus changing the resistance of the strain gauge(s) 108. An electrical circuit, such as a bridge circuit, may be used to measure variations and thus provide an indication of weight loss in the silo 24. When compared with an original weight measurement of proppant within the silo 24, such as via control system 32, the change in weight provides the operator with an indication of how much proppant has been added to the blender 18. When a desired amount has been added, the selective blocking member 102 (FIG. 2) can be closed to stop the release of proppant from the silo 24 into the blender 18.

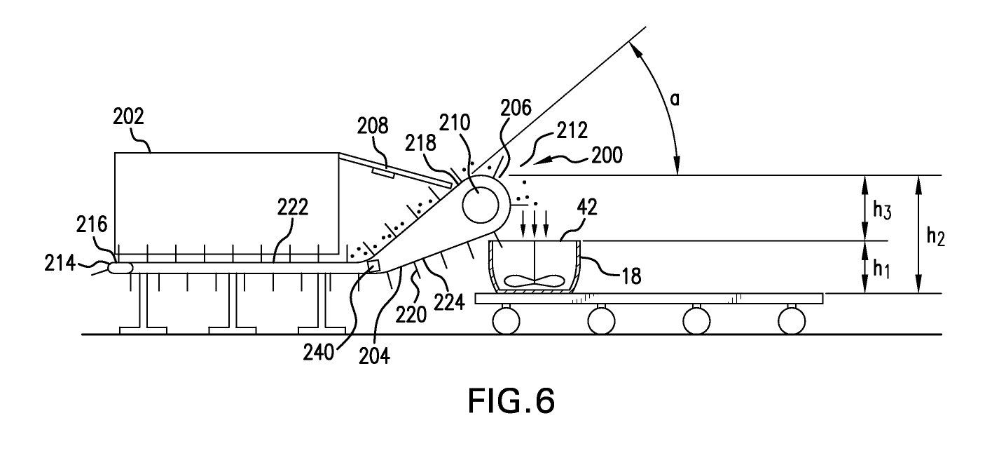

FIG. 6 shows another exemplary embodiment of a proppant delivery system 200. The proppant delivery system 200 may be part of a larger fracturing fluid process plant, such as, but not limited to the fracturing fluid process plant 10 shown in FIG. 1, that would combine water and other components within blender 18 and deliver as needed via pumps. Instead of a vertical silo 24 as used in the proppant delivery system 100, the proppant delivery system 200 delivers proppant to a site using a mobile sand conveying or storage unit, used on-site at drilling locations. For example, a material dispenser 202 may be a mobile sand conveying unit used to deliver sand or other proppant to the well site. The material dispenser 202 dispenses the proppant onto a moving conveyor belt 204 for delivery to blender 18.

A prior art conveyor belt deposits proppant into a hopper that is located at a downstream end of the conveyor belt and carries the proppant to a blender via sand screws, and thus such a conveyor belt is not inclined at all or not sufficiently with respect to a blender in order to deposit directly into a blender. On the contrary, the proppant delivery system 200 includes conveyor belt 204 that is able to deposit directly into the blender 18. In order to accomplish this, the downstream end 206 of the conveyor belt 204 must be positioned at a greater height than a height of the blender 18 at the opening 42, or proppant entrance of the blender 18. In other words, the height h2 (a distance measured from the bottom of the blender 18) to the downstream end 206 of the conveyor belt 204 is greater than the height h1 of the blender 18. That is, the downstream end 206 is positioned a distance h3 above the blender 18. In order to accomplish this, the downstream end 206 of the conveyor belt 204 must be raised a further distance from the ground than what has previously been enabled, or the blender 18 must be lowered. As the blender 18 is typically provided on a trailer for transportability, it may not be practical to dig into the ground in order to deposit the blender 18 at the lower level. Therefore, in one exemplary embodiment as shown in FIG. 6, the downstream end 206 of the conveyor belt 204 is lifted via a cable 208 or other lifting device to position the downstream turning wheel 210 at a position suitable for depositing proppant 212 into the blender 18. In another alternative embodiment, the size of the downstream turning wheel 210 may be increased with respect to the upstream turning wheel 214 at the upstream end 216 of the conveyor belt 204 to increase the incline angle a, which as shown is measured between a line parallel to the supporting surface (such as the ground or trailer) of the blender 18 and the downstream belt portion 218 adjacent the downstream end 206. This angle a will be larger than 0 degrees, which is sometimes the angle of conventional conveyor belts used to deposit proppant into a hopper.

As further shown in FIG. 6, the conveyor belt 204 having an increased incline angle a may be provided with a plurality of holding shelves 220 to prevent the proppant 212 from sliding back towards the upstream portion 222 of the conveyor belt 204 (where the proppant 212 is deposited) during its upward climb towards the blender opening 42. An exemplary embodiment of the holding shelves 220 include at least one protrusion extending outwardly from the belt portion 224 of the conveyor belt 204. The holding self 220 may extend substantially perpendicularly, forming a 90 degree angle between the belt portion 224 and the shelf 220, or may form an acute angle between the belt portion 224 and the shelf 220. Non-moving sidewalls (not shown), may flank the belt portion 224 for preventing any proppant from falling off the sides of the belt portion 224.

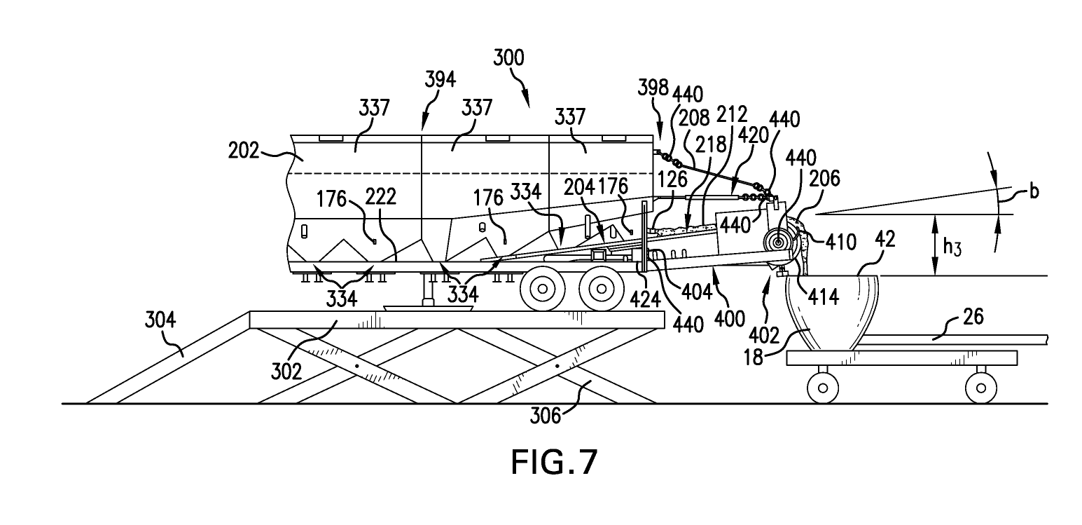

As will be further described below with respect to FIG. 7, the proppant delivery system 200 of FIG. 6 is further provided with at least one weighing device 240, such as a belt scale having a load cell, configured to determine the weight of proppant 212 disposed on the conveyor belt 204, that will weigh the proppant 212 going into the blender 18. The load cell may be the same or similar to that described within respect to FIGS. 4 and 5.

Referring now to FIG. 7, proppant delivery system 300 is shown. In lieu of the angled conveyor belt 204 of FIG. 6, the material dispenser 202 may be raised such that the downstream end 206 of the conveyor belt 204 need not be significantly angled, or may even be substantially level with an upstream portion 222 as shown in FIG. 7, while still maintaining a distance of h3 from the blender opening 42. That is, the angle b is less than the angle a, and may even be 0 degrees. This eliminates any difficulties that might be associated with delivering the proppant 212 up an angled downstream belt portion 218 as in the proppant delivery system 200. Raising the material dispenser 202 may occur by delivering the material dispenser 202 onto a raised surface 302, such as by moving the material dispenser 202 up ramp 304. Alternatively, the material dispenser 202 may be aligned on the surface 302 which is subsequently raised, such as via one or more scissor lifts 306 to the level shown in FIG. 7. In yet another exemplary embodiment, the material dispenser 202 may be lifted such as via a crane to a fixed raised surface 302.

The material dispenser 202 may include one or more hoppers having multiple material storage compartments 337 and multiple dispenser openings 334 associated therewith. The dispenser openings 334 are aligned over the upstream portion 222 of the conveyor belt 204 so that proppant 212 may be dispensed from each compartment 337 onto the conveyor belt 204. An elongated stinger 400, at least one cable 208 and at least one stinger lifting arm 420 are shown extending from the rear end 398 of the main body 394 of the material dispenser 202. The cable 208 may, for example, be a safety cable and the lifting arm 420, when included, may be a hydraulic RAM used to raise and lower the stinger 400. Further details regarding the material dispenser 202 and stinger 400 may be found in U.S. Patent Publication No. US 2014/0041730, which is herein incorporated by reference in its entirety.

In some embodiments, controlling the quantity or rate of proppant 212 discharged off, or delivered by, the conveyor belt 204 may be accomplished by controlling and, if necessary, varying the speed of the conveyor belt 204, the rate the proppant 212 is dispensed from the material dispenser 202 onto the conveyor belt 204, any other suitable manner or a combination thereof. An electronic controller 424 may be configured to assist in measuring and/or controlling the amount of proppant 212 discharged off the downstream end 206 of the conveyor belt 204. The electronic controller 424 may have any suitable form, configuration and operation. For example, the controller 424 may be a programmable logic controller (“PLC”), and may be configured to vary the actual discharge rate. The electronic controller 424 can vary the speed of motor 414 and, thus, the speed of the drive pulley 410 and conveyor belt 204, and the amount of proppant 212 discharged off the end 206 of the conveyor belt 204.

FIG. 7 further shows at least one weighing device 440 configured to determine the weight of proppant 212 on the conveyor belt 204. The output of the weighing device 440 can be used in determining the actual discharge rate. For example, speed data of the conveyor belt 204 or drive pulley 410 along with weight data from the weighing device 440 can be used by the controller 424 or other suitable component to determine the actual discharge rate. In one exemplary embodiment, the weighing device 440 may include one or more strain gage load cells, load sensors and transducers. The weighing device 440 may be located at any suitable location sufficient to weigh the proppant 212 provided onto the conveyor belt 204 from the material dispenser 202. As shown in FIG. 7, for example, a weighing device 440 is positioned at the “pinch point” between the stinger 400 and the main body 394 of the material dispenser 202, generally proximate to hinge 404. Since the exemplary stinger 400 is movable about the hinge(s) 404 relative to the main body 394 of the material dispenser 202 and suspended at its far end 402, the stinger 400 will move down when proppant 212 passes onto or across the portion 218 of the conveyor belt 204 that extends over the stinger 400. As proppant 212 on the conveyor belt 204 passes over the stinger 400, the illustrated weighing device 440 will measure the change in the weight of the stinger 400. For example, the weighing device 440 may be positioned between a first surface on, extending from or connected with the main body 394, and a second surface on, extending from or connected with the stinger 400. As the stinger 400 drops down from the weight of proppant 212 crossing over the belt portion 218, the exemplary weighing device 440 will be squeezed or pinched between the surfaces of the main body 394 and stinger 400 and take a weight measurement.

Alternatively, or additionally, weighing device 440 may be engaged with (or below) the drive pulley 410, such that the drive pulley 410 may be floated on the weighing device 440 so that when proppant 212 on the conveyor belt 204 passes over the drive pulley 410, the pulley 410 will drop and the weighing device 440 will take a measurement. In yet another alternate or additional embodiment, weighing devices 440 may be positioned between the cable 208 and the material dispenser 202, and between the cable 208 and stinger 400, and between the lifting arm 420 and stinger 400, such that as material 212 passes onto or over the end 402 of the stinger 400, downward pulling forces will be placed on the cable 208 and lifting arm 420, at which time the respective weighing device 440 will determine the weight of proppant 212 on the conveyor belt 204. It should also be noted that multiple different weighing devices 440 are shown in for illustrative purposes. While the proppant delivery system 300 may include multiple weighing devices 440, only one weighing device 440 (which may, for example, include one or more strain gage load cells) will be sufficient in many applications. Output from the weighing device(s) 440 may be used, such as by an integrator, to determine an actual discharge rate and provide such information to the controller 424 to effectively meter the amount and rate of proppant 212 discharged off the end 206 of the conveyor belt 204. The components of the system 300 may be configured to communicate wirelessly, via hard wiring, such as cables, or a combination thereof, or may be remotely controlled or monitored.

Because the proppant is already weighed, a density meter is no longer needed at the slurry line 26. Also, the proppant 212 is deposited directly into the blender 18 in lieu of dropped into a hopper and delivered via a sand screw into the blender 18, such that both the hopper and sand screw are no longer required. Removal of the sand screw eliminates a mechanical item that may be subject to failure, thus providing the proppant delivery system 100, 200, 300 with a reduced failure rate through use of the automatic screwless-feeder proppant dispensing units, including the silo 24 and the conveyor belt 204, appropriately positioned with respect to the blender 18. Also, removal of the hopper at the downstream end of the conveyor belt eliminates one “drop” area of the proppant, thus reducing the amount of dust that is imparted at the work site.

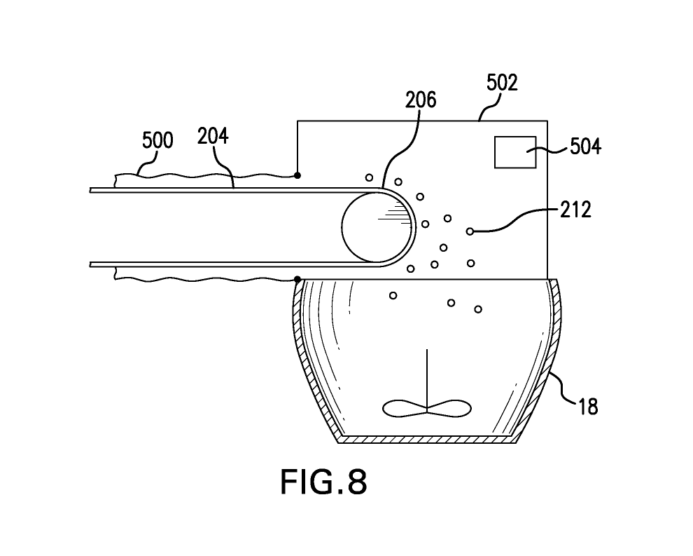

Turning now to FIG. 8, with respect to eliminating or minimizing dust in either of the embodiments of a proppant delivery system 200, 300, the conveyor belt 204 that delivers the proppant 212 from the material dispenser 202 to the blender 18 includes a downstream end 206 that is located in a dispensing position relative to the blender opening 42, and a protective housing 500 may surround a portion or substantially all of the conveyor belt 204 to at least significantly limit the amount of dust entering the environment. The blender 18 may be topped with a protective housing 502 to additionally retain dust in the area of the drop location. The protective housing on the blender 18 may include a fan 504 to draw the proppant dust away from the entrance as needed. The protective housing 500 around the conveyor belt 204 may be flexible and/or telescopic and drawn over the conveyor belt 204 once the downstream end 206 of the conveyor belt 204 is inserted into the protective housing 502 on the blender 18. Alternatively, the protective housing 500 may take the form of a pivotal shield (not shown) attached to the stinger 400 to substantially limit the amount of dust but still provide quick access to the conveyor belt 204 as needed.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A proppant delivery system for a fracturing fluid blending system, the proppant delivery system comprising:
an automatic feed-screwless proppant dispensing unit configured to deliver proppant directly to a blender opening of a blender; and,
a weighing device on an upstream side of the blender configured to weigh the proppant during delivery of the proppant to the blender.

2. The proppant delivery system of claim 1 absent a densometer on a downstream side of the blender.

3. The proppant delivery system of claim 1, wherein the automatic feed-screwless proppant dispensing unit includes a conveyor belt having a downstream end configured to deliver proppant directly to a blender opening of a blender.

4. The proppant delivery system of claim 3, wherein the weighing device is a belt scale.

5. The proppant delivery system of claim 4, wherein the belt scale includes a load cell.

6. The proppant delivery system of claim 3 wherein the conveyor belt includes a plurality of shelves protruding at a non-zero angle from the conveyor belt and movable with the belt.

7. The proppant delivery system of claim 3 wherein a height of a downstream end of the conveyor belt is greater than a height of the blender opening with respect to a bottom of the blender.

8. The proppant delivery system of claim 3 wherein a downstream end of the conveyor belt is distanced above the blender opening.

9. The proppant delivery system of claim 3, further comprising a housing surrounding at least the downstream end of the conveyor belt, wherein the housing at least partially contains dust from the proppant delivered to the blender.

10. The proppant delivery system of claim 1, wherein the automatic feed-screwless proppant dispensing unit includes a silo arranged above the blender, the silo having a downstream end configured to deliver proppant directly to a blender opening of a blender.

11. The proppant delivery system of claim 10, wherein the weighing device includes a load cell configured to detect a loss of weight in the silo as the proppant is delivered to the blender.

12. The proppant delivery system of claim 11, wherein the weighing device is positioned between the blender and the silo.

13. The proppant delivery system of claim 11, wherein the weighing device is positioned within the silo.

14. A method of delivering proppant to a fracturing fluid blender, the method comprising:
arranging a downstream end of a conveyor belt to deliver proppant directly to a blender opening of a blender.

15. A method of delivering proppant to a fracturing fluid blender, the method comprising:
utilizing an automatic feed-screwless proppant dispensing unit to deliver proppant directly to a blender opening of a blender; and,
weighing the proppant during delivery of the proppant to the blender with a weighing device on an upstream side of the blender.

16. The method of claim 15, wherein utilizing an automatic feed-screwless proppant dispensing unit includes arranging a downstream end of a conveyor belt to deliver proppant directly to the blender opening of the blender.

17. The method of claim 16, wherein weighing the proppant includes using a belt scale configured to weigh the proppant on the conveyor belt.

18. The method of claim 16, wherein arranging the downstream end of the conveyor belt includes situating the downstream end of the conveyor belt above the blender tub opening.

19. The method of claim 16, further comprising covering at least the downstream end of the conveyor belt with a housing to contain dust from the proppant.

20. The method of claim 15, wherein utilizing an automatic feed-screwless proppant dispensing unit includes arranging a silo above the blender, the silo having a downstream end configured to deliver proppant directly to a blender opening of a blender.

21. The method of claim 20, wherein weighing the proppant includes using a load cell configured to detect a loss of weight in the silo as the proppant is delivered to the blender.
